(19) United States
(12) Patent Application Publication
(10) Pub. No.: US 2003/0163370 A1
(43) Pub. Date: Aug. 28, 2003

(54) Method and apparatus for measuring user access to image data

(75) Inventors: Simon S. Chen, Los Altos, CA (US); Yen Whei Chow, San Jose, CA (US); Todd Tao Zhou, Milpitas, CA (US)

Correspondence Address: George I. Lee, McDonnell Boehnen Hulbert & Berghoff, 32nd Floor, 300 S. Wacker Drive, Chicago, IL, 60606, US

(73) Assignee: NetRatings, Inc.

(21) Appl. No.: 10/242,305

(22) Filed: Sep. 12, 2002

Related U.S. Application Data
(63) Continuation of application No. 09/266,790, filed on Mar. 12, 1999, now abandoned.

(51) Int. Cl. G06F 17/60

(52) U.S. Cl. 705/14

(57) ABSTRACT

A method and apparatus for allowing the collection of information regarding visits to the pages of a data network such as the Internet, and the number of separate images viewed is described. The described method overcomes various prior art limitations including providing for improved accuracy in reporting the number of times a banner image, such as an advertisement, is viewed; providing improved methods and apparatuses for efficiently identifying unique banner images viewed; providing an improved method and apparatus for configuring a network user's computer so that interference from the data collection process with the normal operation of the computer is minimized; providing an improved method and apparatus for efficiently calculating a checksum to allow unique identification of a banner image viewed by a network user; and providing an improved method and apparatus for determining whether the network user used the browser BACK button to view a page and, if so, to count the banner images viewed.

### BACKGROUND OF THE INVENTION

1. Field of the Invention

The present invention relates to the field of network analysis in general, and in particular, to HTTP based network analysis.

2. Description of the Related Art

Many, if not most of Internet based businesses depend on advertising for revenue generation. One common method of generating revenue is to charge for displaying the advertisements or banner images of third parties. In some cases, instead of charging fees, or as partial consideration for displaying such ad banner images, an exchange program is arranged whereby two entities agree to display each other's banner images on their respective Internet sites. As with any form of advertising, it is important to know how many persons are viewing the particular advertisements or banner images, and what percentage of viewers respond to advertisements by clicking on the ads or by responding to the ads in some measurable manner.

In the sense that revenue is often advertising based, Internet-based business opportunities can be equated to the television industry. In the television industry, the Nielsen™ rating system is perhaps one of the best known media measurement systems. Established in the 1950's, the Nielsen rating system today utilizes monitoring devices at a set of selected user sites to monitor television viewing habits. The Nielsen rating system generates statistical information regarding the number of viewers who have viewed programming on a particular television channel during a particular period.

The Nielsen rating system does not provide information regarding the advertisements that were watched by the viewers. For example, the Nielsen rating system may report that 10 million viewers watched a particular television episode during one particular week. However, no indication is provided regarding the number of viewers that watched a particular advertisement—which was shown during that television episode and was also shown at other times, on the same and other channels—during that week.

A system other than the above-described program rating system collects data on advertisements which are broadcast. It does this by essentially monitoring all television channels and collecting data on the number of times a particular advertisement is broadcast. This system monitors the source of the advertisement (by monitoring the television broadcasts) and, therefore, cannot directly provide information on the number of viewers who viewed a particular advertising campaign during a particular time period. While this data may be combined with data from the Nielsen rating system in order to estimate the number of times a particular advertisement was viewed, this process is, of course, cumbersome and not always accurate.

Further, and perhaps of more relevance to the present invention, it is essentially not possible to collect data from all “broadcasts” at the source in a distributed network such as the Internet—simply because there are too many (perhaps hundreds of thousands, if not millions) of sources of advertisements.

Any number of Internet statistics gathering tools have become available in recent years. In general, these tools can be divided into two categories. First, a large number of tools are available for gathering statistics at the source, e.g., the individual servers. These tools can provide information on the number of Internet pages served, the number of advertisements served, etc. Unfortunately, because they are gathering information from the individual sources, these tools cannot provide a complete picture of the penetration of a full advertising campaign and they are limited in ability to provide information on the demographics of the individuals viewing the advertisements.

Tools are also available to gather information at the viewer's site. Unfortunately, these tools are also limited in their information gathering capability. For example, it is often reported that a particular number of viewers viewed a particular uniform resource locator (URL) during a particular time period. Unfortunately, these tools are not able to report information on individual advertisements viewed. For example, even if it is known that a URL identifies an advertisement, the URL does not necessarily uniquely identify any particular advertisement. This is in part because the advertisements are often “served” from an ad server which rotates advertisement banner image images under the same URL.

What is needed is a system which can accurately measure the number of on-line users that are presented with specific advertisements, and which can provide additional statistical reporting regarding user interaction with specific advertisements or other image data.

Accordingly, it is an object of the present invention to provide a method and apparatus which accurately measures the number of times a banner image image (or other image) is viewed by a network user, and which identifies the unique images viewed by each particular on-line user.

It is still another object of the present invention to accomplish the above-stated objects by utilizing a method and apparatus which is simple in use and design, and efficient in reducing interference with the normal operation of a user's computer.

The foregoing objects and advantages of the invention are illustrative of those which can be achieved by the present invention and are not intended to be exhaustive or limiting of the possible advantages which can be realized. Thus, these and other objects and advantages of the invention will be apparent from the description herein or can be learned from practicing the invention, both as embodied herein or as modified in view of any variation which may be apparent to those skilled in the art. Accordingly, the present invention resides in the novel methods, arrangements, combinations and improvements herein shown and described.

### SUMMARY OF THE INVENTION

In accordance with these and other objects of the invention, a brief summary of the present invention is presented. Some simplifications and omissions may be made in the following summary, which is intended to highlight and introduce some aspects of the present invention, but not to limit its scope. Detailed descriptions of a preferred exemplary embodiment adequate to allow those of ordinary skill in the art to make and use the inventive concepts will follow in later sections.

According to broad aspects of the invention, methods and apparatuses for providing information regarding the number of visits to pages on a data network such as the Internet and banner images encountered on network pages are described. The described embodiments overcome a number of issues faced by prior art systems, including providing for improved accuracy in measuring the number of times a banner image or advertisement is viewed; providing improved methods and apparatuses for efficiently identifying unique banner images viewed; providing an improved method and apparatus for configuring a network user's computer so that interference from the collection of data with the normal operation of the computer is minimized; providing an improved method and apparatus for efficiently calculating an image checksum to allow unique identification of a banner image viewed by an end user; and providing an improved method and apparatus for determining whether the network user has used the BACK button of an Internet browser to view a page and, if so, to accurately count the number of banner images viewed.

### BRIEF DESCRIPTION OF THE DRAWINGS

FIG. 1 is a representation of an Internet page as may be monitored by an embodiment of the present invention.

FIG. 2 is an overall diagram of a network as may be utilized by an embodiment of the present invention.

FIG. 3A is a high level block diagram of a first embodiment of a client computer as may be utilized by the present invention.

FIG. 3B is a high level block diagram of a second embodiment of a client computer as may be utilized by the present invention.

FIG. 4 is a flow diagram illustrating a data collection method as may be implemented by an embodiment of the present invention.

FIG. 5 is a flow diagram illustrating a method of identifying banner images in Internet pages as may be utilized by the present invention.

FIG. 6 is a representation of an Internet page using frames as may be monitored by an embodiment of the present invention.

FIG. 7 is a flow diagram illustrating a method of monitoring frame pages as may be utilized by an embodiment of the present invention.

FIG. 8 is a flow diagram illustrating a method of BACK button processing as may be utilized by an embodiment of the present invention.

FIG. 9 is a diagram illustrating certain panel member demographics which may be utilized by an embodiment of the present invention.

FIG. 10 is an illustration of a report format as may be utilized by an embodiment of the present invention.

FIG. 11 is an overall flow diagram of a method of retrieving images as may be utilized by the present invention.

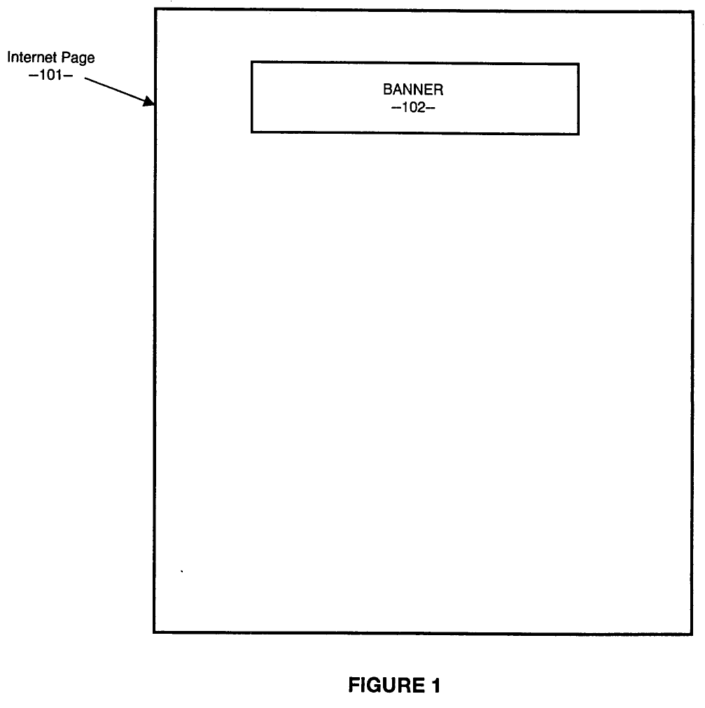

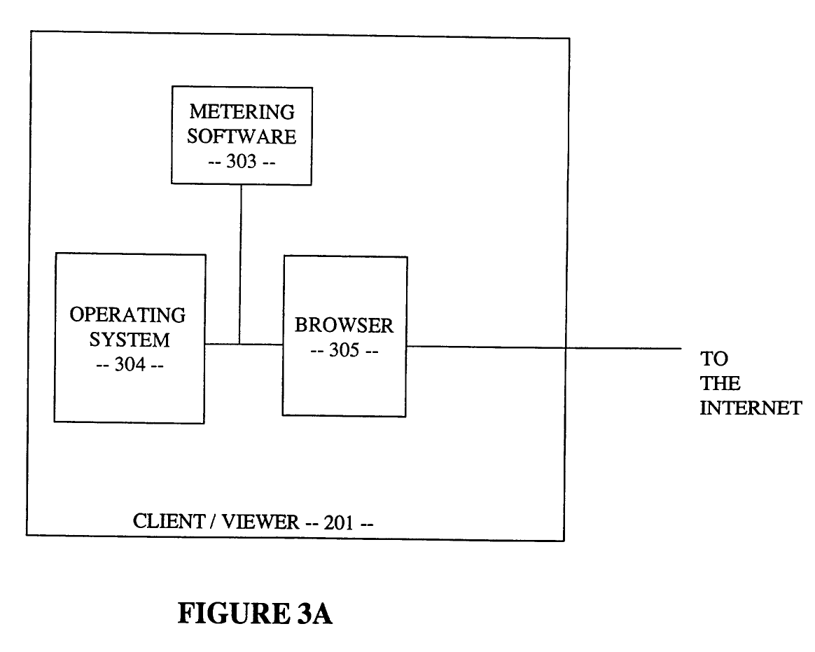

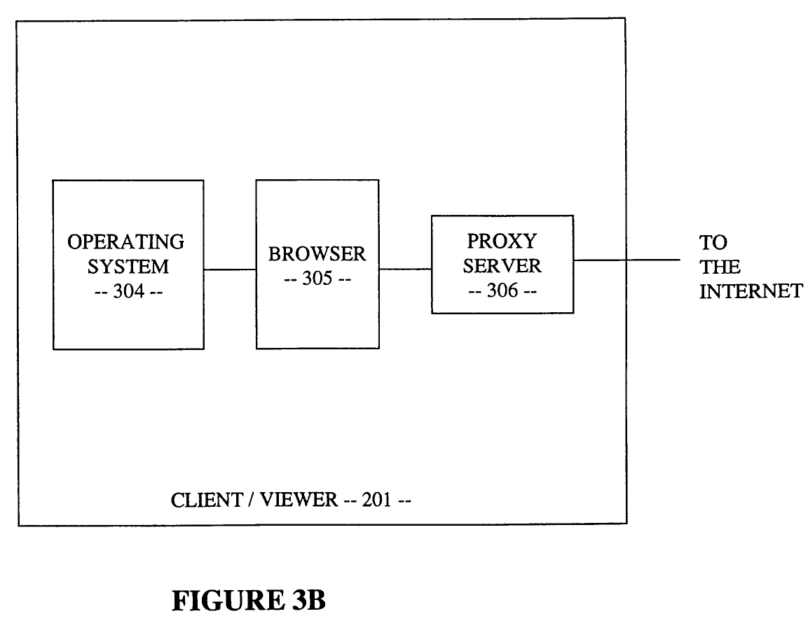

For ease of reference, the numerals in all of the accompanying drawings are usually in the form “drawing number” followed by two digits, xx; for example, reference numerals on FIG. 1 may be numbered 1xx; on FIG. 3, reference numerals may be numbered 3xx. In certain cases, a reference numeral may be introduced on one drawing and the same reference numeral may be utilized on other drawings to refer to the same item.

### DETAILED DESCRIPTION OF THE EMBODIMENTS THE PRESENT INVENTION

I. Overview of HTML for Banner Images

FIG. 1 illustrates an Internet 101 which includes a separate image 102 that could be a hyperlink represented as a graphic “button”, or a banner containing an advertisement. The image 102 is also referred to herein as a “banner image,” “image,” “advertisement” “banner” or simply an “ad.” A network user viewing the Internet page (a “viewer,” “end user” or “panel member”) may ignore the banner image 102, simply look at the banner image 102 or, more actively, select the banner image 102 (such as by clicking on it with a cursor control device). By selecting the banner image 102, the viewer may be presented with another Internet page which may provide, for example, another page of information or another page providing more detail on a company placing an advertisement or on a product being advertised in the banner image 102. Alternatively, the banner image 102 may provide one form or another of rich new media such as audio or video programming content.

Internet pages are typically constructed using a programming language called hypertext markup language (HTML). It is, in fact, the HTML code which is transmitted from an Internet server to the requesting machine in response to a viewer requesting a particular Internet page or site (identified by its uniform resource locator or “URL”). Internet pages which include banner images 102 have encoded in their HTML what will be termed herein “anchor pairs”. An anchor pair comprises the HTML code for the URL to contact if the user selects the banner image 102, together with the URL for the image to display in the banner. An example of an anchor pair is shown below in Table I.

TABLE I
ANCHOR PAW

href=“http://www.digitalriver.com/dr/v2/ec_MAIN.Entry17c?
CID=5560&SID=6505&SP=10007&PN=5&PID=100853”>Buy Speedlane Software
Online!</A></FONT></B></P><TABLE WIDTH=“120”BORDER=“0”
CELLPADDING=“0” CELLSPACING=“0” ALIGN=“RIGHT”><TR>
<TD><IMG SRC=“/graphics/spacer.gif” WIDTH=“20” HEIGHT=“4” BORDER=“0”
ALIGN=“BOTTOM”></TD><TD><a

There is not necessarily a one-to-one correspondence between advertising images and the URL encoded in the HTML for the anchor pair. In fact, there may be a many-to-many correspondence. For example, the advertising image may be provided from an advertising server. Thus, the particular image served may vary every time that an Internet page is accessed although the URL for the page remains constant. An example of the HTML for this is shown in Table II.

TABLE II
ANCHOR PAIR

<a href=“/cgi-bin/gen_addframe.cgi?addhref=http://209.1.112.252/cgi-
bin/redirect/follow.cgi%3fdc%3dsCA%2bz94086%2bcUS%2bgM%2baR%2bm9%2bn9%2bi
H%2blG%2beS%2bjP%2bqC%2buO%2bw0%2bh2058%2bd1%2bd2%2bd4%2bd7%2bd11
%2bbN%2bo5%2btF&login=xxxxx” onMouseOver=“self.status=‘Please click on the banner
for more information’; return true” target=“_top”>
<img src=“http://209.1.112.252/adgraph/follow.gif” width=468 height=60 alt=“[Click our
Sponsor's banner, with Easy Return to Hotmail.]” hspace=0 vspace=0
border=0></a></td></tr>

Moreover, the same advertising image may be associated with any number of URLs. For example, a particular advertiser may contract with multiple advertising server companies to place its advertisement on multiple Internet pages. There will be at least one, if not many, different URLs used by each advertising server company to serve the advertisement.

Thus, it is not possible to accurately track the number of times an advertisement is viewed by simply tracking URLs.

II. Overview of an Exemplary Embodiment for Tracking Internet Based Advertisment Viewing

Similar to the Nielsen rating system, it is possible to recruit a panel of viewers which provide a statistically representative sample of a population of data network users, such as Internet users, in order to provide statistically interesting data regarding data access habits and preferences.

In one exemplary embodiment, an index group of approximately 2000 Internet users was developed using random digit dialing to insure demographic accuracy and projectability of the panel member's behavior to the population of Internet users. After demographic profiles of the index panel were established, an additional 23,000 (for 25,000 total) members that fit the demographic profiles were selected via Internet recruiting. Internet recruiting is a relatively cost effective method of recruiting panel members. Periodic, e.g., quarterly, re-calibration of the index panel is employed in the process of recruiting new panel members to reflect the changing population of the Internet user community.

When a panel member is selected, the panel member completes a survey which identifies certain key demographic and psychographic data to allow a profile of the user to be built. As will be described below, the panel member then instructs his or her computer to allow the collection of information regarding advertisements received by the panel member's computer while the panel member is “surfing the Internet”.

III. Overall Architecture

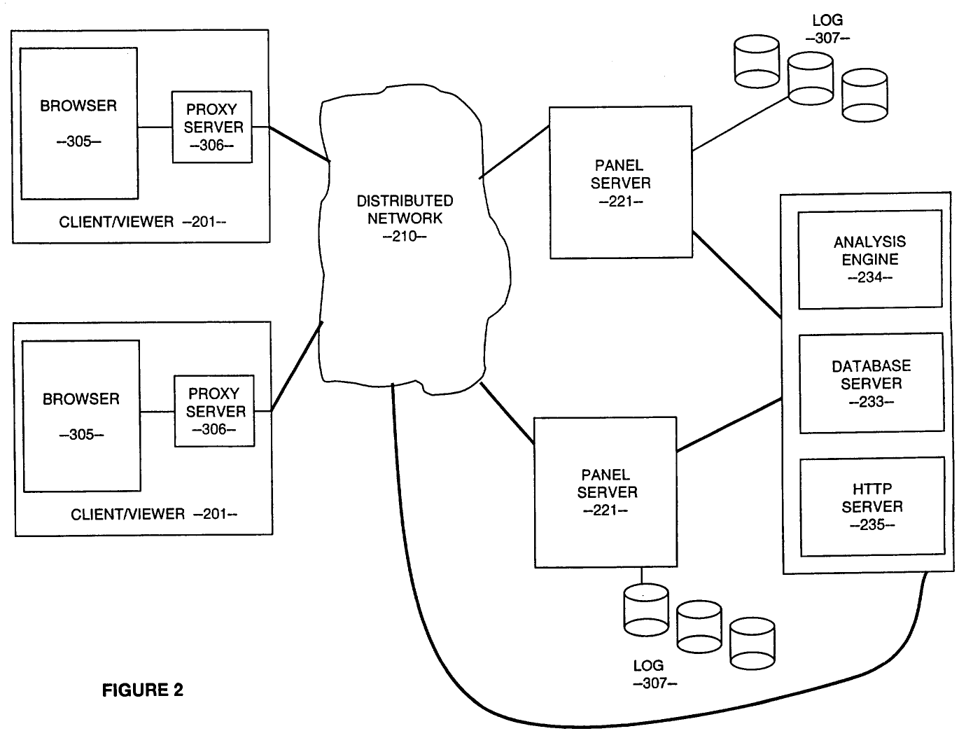

FIG. 2 provides a high level overall view of the architecture of one preferred embodiment of the present invention. In FIG. 2, the general relationship among the features of the system is shown as used in a distributed network environment 210 such as the Internet.

A plurality of panel member client/viewer terminal devices or computers 201 are configured to collect information relating to specific banner images 102, such as advertisements. These advertisements are typically viewed as a result of accessing world wide web sites or pages on the Internet 210. The panel member computers 201 may be based on any of a number of platforms executing various operating systems and browsers. For example, the platform may be executing any of a number of different operating systems including UNIX, the Macintosh OS™, or the Windows™ operating system. The platform may also be executing any of a number of Internet browsers including, for example, browsers available from Netscape Corporation or Microsoft Corporation or browsers available from online service providers such as AOL, Compuserve or Prodigy. Advantageously, the present invention requires little, if any, modification for use on these varying platforms and is relatively simple to install.

It should be understood that the references to specific programs or components typically found in general purpose computer terminals and servers, related to but not forming part of the invention, are provided for illustrative purposes only. References to computer programs and components are provided for ease in understanding how the present invention may be practiced in conjunction with known types of on-line database and data network/Internet applications. Moreover, it is important to understand that the various components of the system contemplated by the present invention may be implemented by software programs, by direct electrical connection through customized integrated circuits, or a combination of circuitry and programming, using any of the methods known in the industry for providing the functions described herein without departing from the teachings of the invention. Those skilled in the art will appreciate that from the disclosure of the invention provided herein, both programming languages and commercial semiconductor integrated circuit technology would suggest numerous alternatives for actual implementation of the functions herein that would still be within the scope of the present invention.

In one preferred embodiment, the computers 201 are further configured with a proxy server architecture. Use of the proxy server architecture provides a number of advantages including ease of portability from platform to platform. The proxy server architecture will be described in greater detail with reference to FIGS. 3A & 3B.

Data is collected by a proxy server 306 when a panel member's computer 201 accesses a distributed network 210. The collected data is transmitted back over the distributed network 210, in this example the Internet, and is reported to a panel server 221. The collected data includes, among other items, a banner image link URL, a banner image URL, and a checksum/length field for each banner image 102 presented to or viewed by a panel member. The panel server 221 receives the collected data, and logs it in one or more data logs 307.

The panel server 221 preferably executes on a NT/Pentium based general purpose computer. In the described embodiment, a plurality of panel servers 221 are provided in order to assure high availability and fast user access. The particular number of panel servers 221 may vary from embodiment to embodiment and may depend on such as factors as the size and speed of the panel server 221, the number of panel members in the sample population, etc.

The panel server 221 also provides the collected data to a database server 233 for further processing. The database server 233 performs the function of overall database management for the system of the present invention. In the described embodiment, an Oracle relational database server is utilized. However, alternative embodiments may utilize any of a number of database servers and, in fact, the database server 233 may utilize either a relational or non-relational database without departure from the spirit and scope of the present invention.

In the described embodiment, there are two main sources of data. First, demographic data is collected and stored with respect to the makeup of the members of a panel. The demographic data may include information such as gender, age, marital status, educational level, race, employment status, income level, industry of employment, occupation, and geographic region information. It is anticipated that a panel of 25,000 members will generate about 300 MB of data per day, to be received and processed by the database server 233.

The database server 233 stores the banner images 102 for each unique banner image 102 that is encountered. The database server 233 performs the function of correlating the foregoing data to generate reports, as will be described in greater detail below.

Periodically (e.g., daily), an analysis engine 234 analyzes the data correlated by the database server 233 and stored in the database. The analysis engine 234 performs several tasks, including that of obtaining the banner images 102 for each advertisement presented to a panel member. As described above, there is a many-to-many relationship between the advertisement images and the URLs. A method for determining the particular advertisement image viewed is described in greater detail below.

Subscribers to the system may access the database in order to obtain reporting on advertisements viewed. In the described embodiment, the subscribers may access the database through a HTTP server 235. In alternative embodiments, subscribers may be given alternative access. For example, subscribers may be given direct dial-in access or may be provided with reports periodically by facsimile, mail or email.

IV. Configuration of the Panel Member's Computer

One method of configuring a panel member's computer is illustrated generally in an exemplary embodiment shown in FIG. 3A. In FIG. 3A, a panel member's computer 201 is configured by installing metering software 303 designed to intercept messages communicated between the operating system 304 and a browser 305. While this technique may be utilized in certain embodiments of the present invention, design and development of metering software 303 for each of the many platforms which may need to be supported is likely to be cumbersome because the metering software 303 must be customized for each browser/operating system combination. It should be noted that configuration of a panel member's computer 201 may be accomplished by any of a number of techniques that implement the foregoing functions without departing from the inventive aspects of the present invention. For example, in the embodiment described above, the present invention combines the proxy server 306 with a browser 305 to intercept messages communicated between the operating system 304 and a browser 305 (see FIG. 3B).

It has been discovered that it is advantageous to configure the computer 201 as illustrated in FIG. 3B, by providing the proxy server 306 to collect data related to the banner images 102 accessed by a panel member. One distinct advantage of use of the proxy server 306 over metering software 303 is that use of the proxy server 221 allows for the development of relatively portable code.

V. System Operation

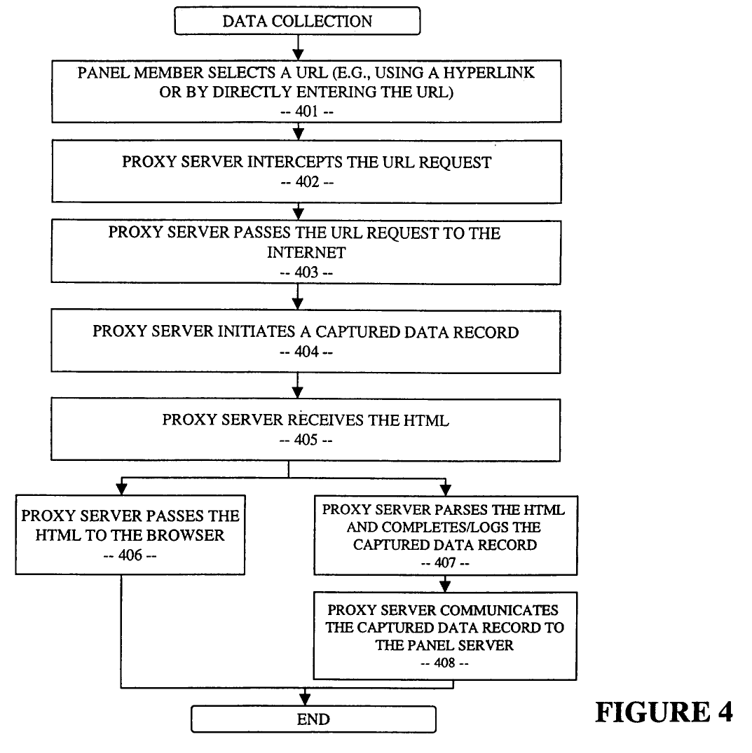

The components of FIG. 3B are best understood by referring to the system's data collection process illustrated in the flowchart shown in FIG. 4. In operation, a panel member first selects a URL using any of a number of conventional browsing methods, such as selecting a hyperlink or directly typing the URL into the an Internet browser 305 (Block 401). The proxy server 306 intercepts the URL request (Block 402) and passes the URL request onto the Internet 210, where the request is served in the conventional manner (Block 403).

The proxy server 306 then initiates generation of what will be termed a “captured data record” (Block 404). The captured data record provides information relating to the URL request, the HTML data received, the panel member's use of the Internet page, and advertising banner images 102 encountered on the Internet page. In one embodiment of the present invention, the captured data record preferably comprises the information identified below in Table III:

TABLE III

| | FIELD | DESCRIPTION |
|---|---|---|
| 1 | VERSION NUMBER | Version number of proxy software |
| 2 | SITE ID | Used by the panel server and database server |
| | | to identify the panel member's computer |
| 3 | USER ID | Used by the panel server and database server |
| | | to identify the panel member |
| 4 | REQUESTED URL | The URL requested by the panel member |
| 5 | METHOD | HTTP methods supported by the target of the |
| | | hypertext link. The most common methods |
| | | are GET, HEAD and POST. |
| 6 | REFERRER | The URL of the referring page (only |
| | | applicable in the case of a hyperlink) |
| 7 | REQUEST TIME OF | The time of day that the user requested the |
| | URL (GMT) | URL (in GMT) |
| 8 | REQUEST TIME OF | The time of day that the user requested the |
| | URL (LOCAL) | URL (in local time) |

In addition, the following fields, shown in Table IV are generated or collected for each banner image 102 found in the HTML page that is viewed:

| | FIELD | DESCRIPTION |
|---|---|---|
| 9 | BANNER IMAGE | The URL of the banner image 102 anchor |
| | ANCHOR URL | (page to go to if the panelist clicks on the |
| | | banner image 102) |
| 10 | BANNER IMAGE | The URL of the banner image 102 |
| | URL | |
| 11 | CHECKSUM | A calculated checksum for the banner image |
| | | 102. |
| 12 | LENGTH | The length of the banner image 102 in bytes |

The length of each captured data record is approximately 500 bytes. Keeping the amount of captured data which must be transmitted to the panel server 221 minimal is important to avoid undue interference with the performance of the panel member's computer 201. The operation of the present invention must be as unobtrusive as possible so that it does not unnecessarily interfere with the panel member's experience while accessing the Internet. Interference with the panel member's experience may result in changes in the behavior of the panel member and, in the case of significant interference, may result in the panel member removing himself or herself from the pool of panel members.

It should be noted that in alternative embodiments, alternative types of browsing data may be transmitted with the captured data record, which may have an impact on the overall length of the captured data record and the level of useful information collected. For example, in addition to transmitting the URL of the banner image 102, the full image may be transmitted. While transmitting the full banner image 102 may provide useful information for the analysis engine 234, transmission of the full banner image 102 is relatively expensive both in terms of bandwidth consumed in transmission of the image and in terms of storage requirements.

Instead of transmitting the data for each entire banner image 102, a checksum is preferably calculated for the banner image 102 and reported in the captured data record. In one embodiment of the present invention, the checksum is calculated against only a sampling of the banner image 102. The amount of image data sampling is variable, and can be set based on the desired exactness in identifying specific banner images 102. By calculating the checksum against only a sampling of the banner image 102, processing bandwidth is saved when compared with calculating the checksum for the entire image. For example, in the described embodiment, only recurrent bytes (e.g., every 4^{th} or 5^{th} byte) are used in the checksum calculation.

While using only a portion of the banner image 102 to calculate a checksum can advantageously reduce processing requirements, it does not provide the same level of assurance that the checksum will represent a unique value identifying, for example, an advertisement, as would be provided if the checksum were calculated for the entire banner image 102. As can be understood, varying the checksum sampling rate allows for varying the reliability of the results against the benefit of saving computational cycles and bandwidth.

At times there may be only minute differences between two images 102, such as where two advertisements are produced by a single advertiser. In such a case, if the differences do not occur in the recurrent bytes sampled to generate the checksum, the checksum will not uniquely identify the advertisement image. To overcome this problem, the total length of the advertising image is calculated in addition to the checksum. In one embodiment of the present invention, the length of the banner image 102 in bytes is determined and provided in the captured data record for the page.

This combination of checksum and length values are used to uniquely identify each specific banner image 102 that is encountered. It is been determined empirically that, while not providing absolute assurance that the checksum/length combination will always identify a specific advertising image, the use of the combined checksum/length value is sufficiently reliable for purposes of the described embodiment.

It is worthwhile pointing out that in alternative embodiments, alternative information may be used to uniquely identify a banner image 102. One example was briefly discussed above—storing and transmitting the entire banner image 102, with the inherent sacrifice in storage and transmission bandwidth. As also discussed above, a checksum could be calculated on the entire banner image 102 with the inherent additional costs in processing, storage and transmission requirements. For purposes of the discussion herein, data uniquely identifying a banner image 102, regardless of the method used to generate the identifying information, will be referred to generically as a “unique banner image identifier”. Generating a unique banner image identifier for identifying a specific image eases the process of counting and analyzing the number of times a particular image has been displayed.

Unlike the banner image data, certain of the fields in the captured data record may be determined prior to receiving the HTML data (e.g., USER ID and REQUEST TIME OF URL) while other fields will necessarily have to be determined after the HTML data is received. In any event, the HTML data corresponding to the requested URL is eventually received by the proxy server 306 (Block 405). The proxy server 306 then passes the HTML data onto the browser 305 (Block 406).

As one important aspect of the present invention, the proxy server 306 examines the HTML data to find additional banner images 102. Each captured data record may include data relating to 0−n banner images 102, depending on the number of banner images 102 found in the HTML data. The proxy server 306 completes its generation of the captured data record and communicates the captured data record over the network 210 to data log 307 (Block 407). The data are also communicated over the network 210 to the panel server 221 (Block 408).

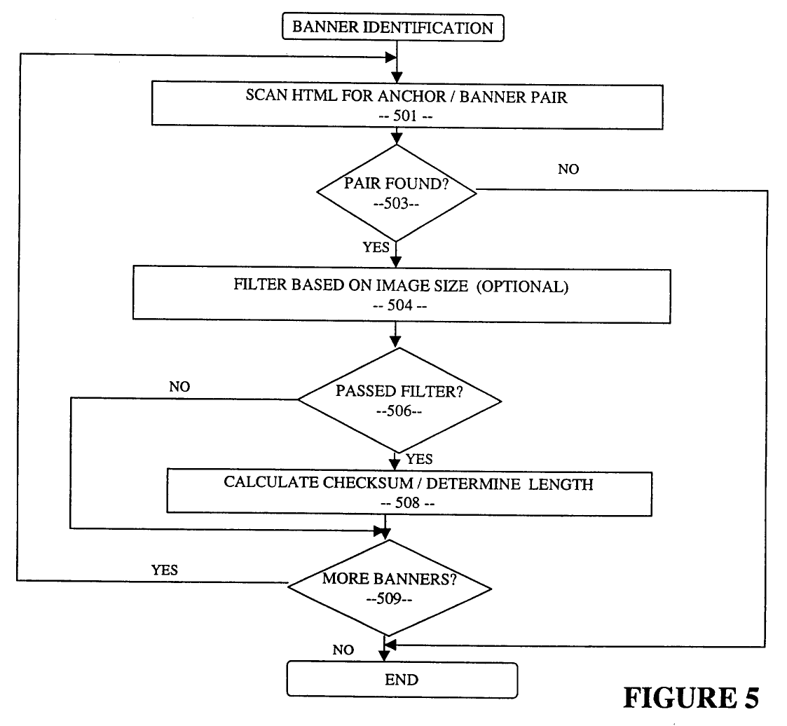

Turning now to FIG. 5, a method of identifying banner images 102 as may be implemented in the described embodiment is illustrated. Initially, the HTML code of a page that a panel member is viewing is scanned for anchor/banner image 102 pairs (Block 501). As described above, anchor/banner image 102 pairs contain the HTML code for the URL to contact if the user selects the banner image 102, together with the URL for the image to display in the banner 102.

The system of the present invention scans the entire HTML page for all anchor/banner image 102 pairs, and if no anchor/banner image 102 pair is found, then the process completes without going through any banner identification (Block 503 to END).

If a pair of anchor/banner images 102 is found (Block 503), the present invention (optionally) filters the anchor/banner image 102 pairs to screen out images which do not likely represent banner images 102 based on the image size (Block 504). For example, images such as graphic “buttons” to be clicked on for hyperlinking could be confused for advertisements if any image size is accepted. Image size is determined by multiplying the width of the image times the height of the image (in pixels). One embodiment of the present invention uses a minimum image size threshold to filter images. In another embodiment, the filtering process requires that the image size exceed a first threshold but be smaller than a second threshold.

The filter thresholds in the described embodiment are variable, and may be set based on empirical observations that the size of particular banner images 102, such as advertisements, likely fall within a certain range. For example, as the size of advertising banner images 102 becomes increasing standardized, it should be easier to filter out images which do not fit within one of the standard sizes.

If an image does not pass the filtering process (Block 506), the system then checks if more HTML code is present and reverts to Block 501 to continue scanning the remainder of the HTML code for any banner images 102 that may be present. After all of the HTML code is scanned and no images are found, the process is completed. If an image does pass through the preset thresholds of the filtering process (Block 506), then the combination checksum/length value is computed for the banner image 102 in the process described above to identify the specific advertisement (Block 508). The entire process is completed for each image found as the remainder of the HTML code of the page is scanned (Block 509).

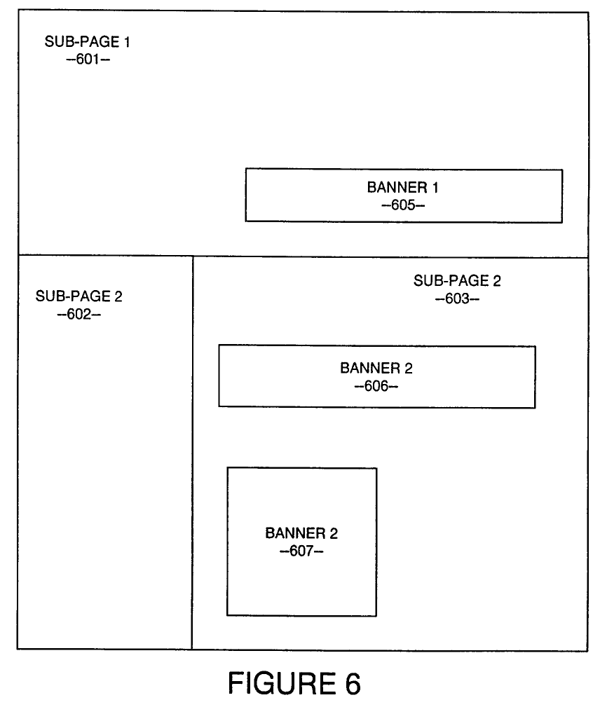

The system of the present invention is designed to perform the foregoing processes even if the HTML page received utilizes frames technology. An HTML page using frames is shown in FIG. 6. Since there are 3 sub-pages in the exemplary page illustrated by FIG. 6, there will be 4 URLs downloaded by the browser. They are represented generally as:

http://domain.com/mainframe.html

http://domain.com/sub-page1.html

http://domain.com/sub-page2.html

http://domain.com/sub-page3.html

The downloading sequence is typically the “Main frame” first, followed by the three sub-pages. The three sub-pages are downloaded concurrently via multithreads by the browser 305. As was described above, the proxy server 306 is designed to transmit to the panel server 221 one captured data record for each HTML page viewed. In non-frames HTML, a single HTML page corresponds to a single URL being downloaded by the proxy server 306. As is seen, in a frame HTML page, a single page may require multiple URL requests. However, it is still desirable to send a single data record that corresponds to the panel member's access of the multi-frame page. Thus, as another aspect of the present invention, a method is disclosed for detecting that a HTML page is a frame page and transmitting a single captured data record to the panel server 221 for each frame page.

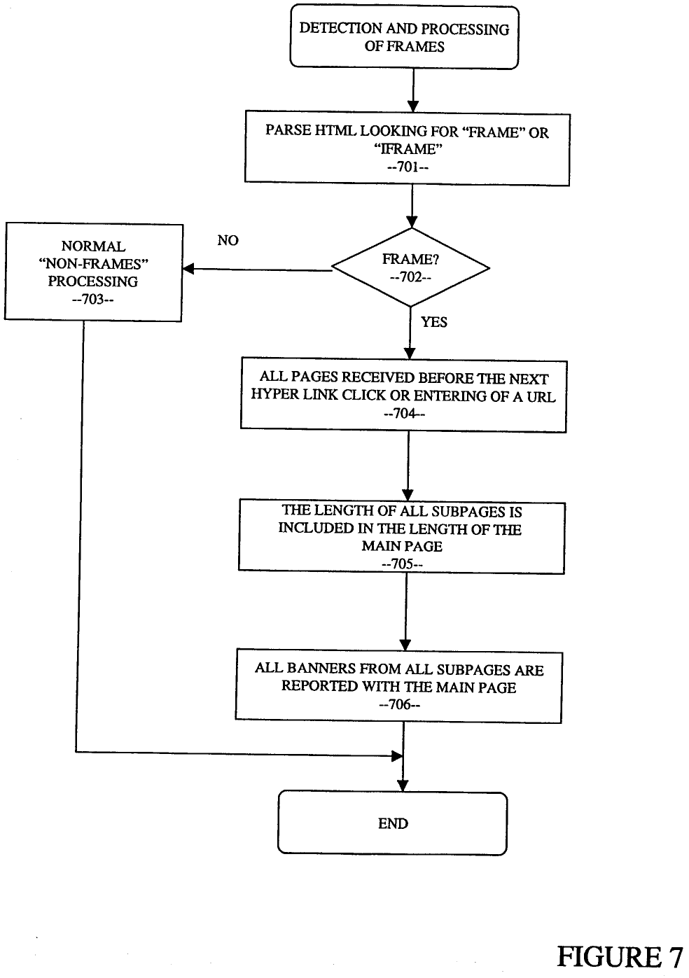

Referring now to FIG. 7, the method is described in greater detail. Initially, each page of HTML code that is received is parsed to identify the HTML tag “FRAME” or “IFRAME” (Block 701). If the tag is not found (Block 702), the page is identified as not being a main page for a frame, and is processed (searching for banner images 102, adding up the page length, etc.) in accordance with the methods described above (Block 703).

If the tag is found, the system initiates the identification of any sub-frames that may exist. As understood by those skilled in the art, sub-pages of a frame are typically received by the user's computer 201 within a predetermined amount of time after the main frame is received. In the present invention, all pages received before the next hyperlink selection or the entering of a URL by a panel member (a page with a FRAME tag), are identified as sub-pages (Block 704). The length of all sub-pages is included with the length determined for the main page, and the combination of data is included in the captured data record for the main page (Block 705). In addition, all banner images 102 in each of the sub-pages is identified using the processes described above, and the data for such images 102 are generated along with the captured data record of the main page (Block 706). As can be seen, the data related to each sub-page is handled in combination with the data for the main page of a multi-frame page.

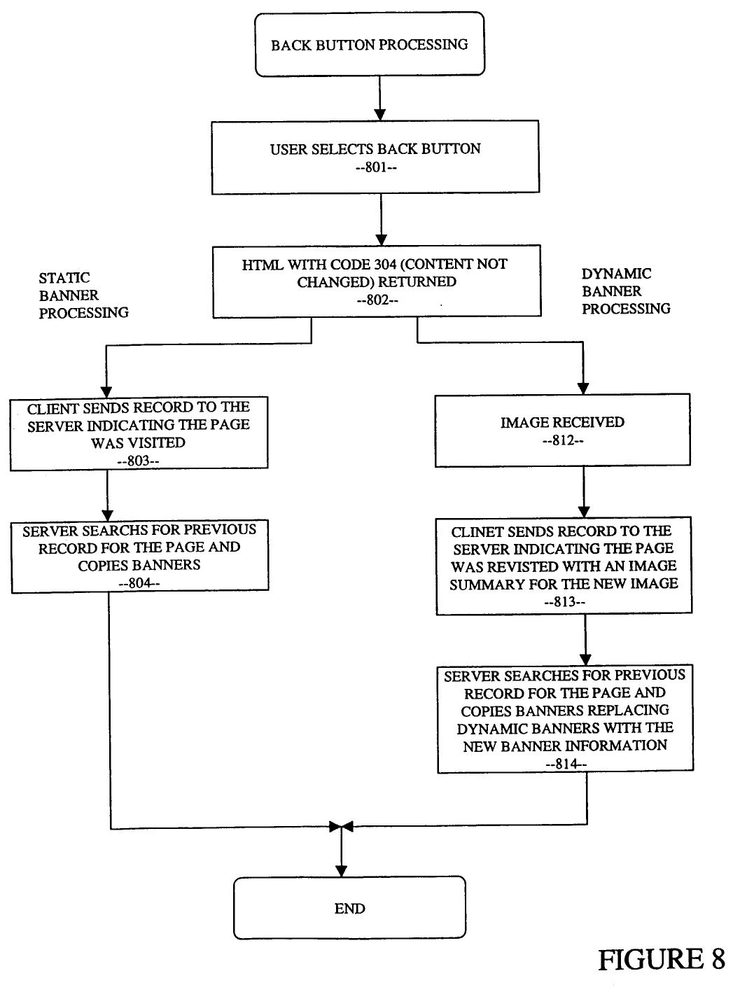

Turning now to FIG. 8, a method for accounting for use of the BACK button of a browser 305 is explained. When a user clicks the BACK button of the browser program (Block 801), the browser 305 usually displays a page from its cache memory. If the page is retrieved from cache, it may not be reported by the proxy server 306 and thus, an inaccurate count of the number of times a particular Internet page (and the associated advertisements or banner images 102) is viewed will result. Thus, as one aspect of the described embodiment, the proxy server 306 forces a reload of the HTML code every time that the user selects the BACK button in order to accurately calculate the number of times a banner image 102 is actually viewed.

The reloaded page normally has HTTP status code 304: no new content (Block 802). Thus, if a page has banner images 102 and the reload page is returned with a status code 304, special handling of the HTML page is provided in the present invention in order to avoid the loss of banner image 102 information. This handling is done in one of two ways dependent on whether the banner image 102 is static or dynamic.

Static banner images—Static banner images are banner images 102 which do not change each time a browser reloads a HTML page. Therefore, when the user selects the BACK button, the static banner images 102 in that re-visited page do not change and the user sees the same banner image 102 again. As was just mentioned, when the HTML page has a status code 304, there is no new content and therefore the proxy server 306 does not parse the HTML code for banner images 102. According to one aspect of the present invention, when the proxy server 306 detects the status code 304, it sends a message to the panel server 221 stating that the previous page has already been visited (Block 803). The panel server 221 communicates the message to the database server 233. The analysis engine 234, which is configured to recurrently search its records, will check for the previously visited page (by matching URLs) and copy the banner image 102 information associated with the previously visited page into a new data capture record (Block 804).

Assume, for example, the user visits an Internet page http://domain.com/page1.html with 2 banner images B1 and B2. The proxy server 306 will send a message to the panel server 221 with the content: http://domain.com/page1.html, 200, B1, B2, where 200 is the status code for the page (normal). If the user then visits another page, http://domain.com/page2.html, the proxy server 306 sends a message with the content: http://domain.com/page2.html, 200. If the user then selects the BACK button of the browser 305, the record: http://domain.com/page1.html, 304 is sent to the panel server 221, inserted into the database server 233 and then the analysis engine 234 searches its previous records for the entries for the page http://domain.com/page1.html and copies the banner images 102 from that entry such that the final entry in the database server 233 records is:

http://domain.com/page1.html, 304, B1, B2.

It should be noted that in an alternative embodiment, the records for previously visited pages may be stored and searched locally at the client system. This would, however, add overhead processing to the client system.

Dynamic banner images—Dynamic banner images are banner images 102 which change each time a page is accessed even if the HTML page which contains the banner images 102 does not change. It is possible that an Internet page contains both static and dynamic banner images 102. For example, assume page1 contains two banner images 102 (as was described in the previous example), banner images B1 and B2. Assume that banner image B1 is a static banner image 102 and banner image B2 is a dynamic banner image 102. When the user selects the BACK button of the browser 305, the user sees a different banner image 102 (banner image 102 B3) in place of banner image 102 B2.

The present invention will record the fact that banner image 102 B1 and B3 were viewed when the BACK button was selected. As discussed above, a checksum/length value is calculated for each banner image 102 that is viewed. In the example given above, the first time that the user visited the Internet page, the length/checksum was calculated for banner images B1 and B2 as:

B1, L1, C1

B2, L2, C2

(where Bn=banner/anchor pair; Ln=banner length; Cn=checksum)

This length and checksum information will be sent to the panel server 221 as part of the data capture record for the HTML page.

According to the BACK button process of one embodiment of the present invention, the second time the user visits the page by selecting the BACK button, the HTML page is returned with a no new content status having a status code 304 (Block 801 & 802). The dynamic banner image 102 uses the same URL as the original banner image 102, however its content is changed. An image (for banner image 102 B3) is received by the panel member's computer 201 (Block 812). The banner image 102 information (e.g., B3, L3, C3) is sent to the panel server 221 indicating that the HTML page was revisited, along with an image summary for the new image B3 (Block 813). The panel server 221 then updates the data capture record by searching its database, replacing the data related to the first dynamic banner image 102 with the data related to the new banner B3 (Block 814).

As has been discussed, one of the difficulties in collecting and analyzing information regarding advertisements or banner images 102 on the Internet is that there is a many-to-many relationship between the advertisements and URLs identifying the advertisements. It has now been described that for each advertisements viewed, the panel member's computer 201 reports, among other data, the banner image URL, a banner image checksum and a banner image length. The analysis engine 234 uses this information to uniquely identify the advertisements viewed.

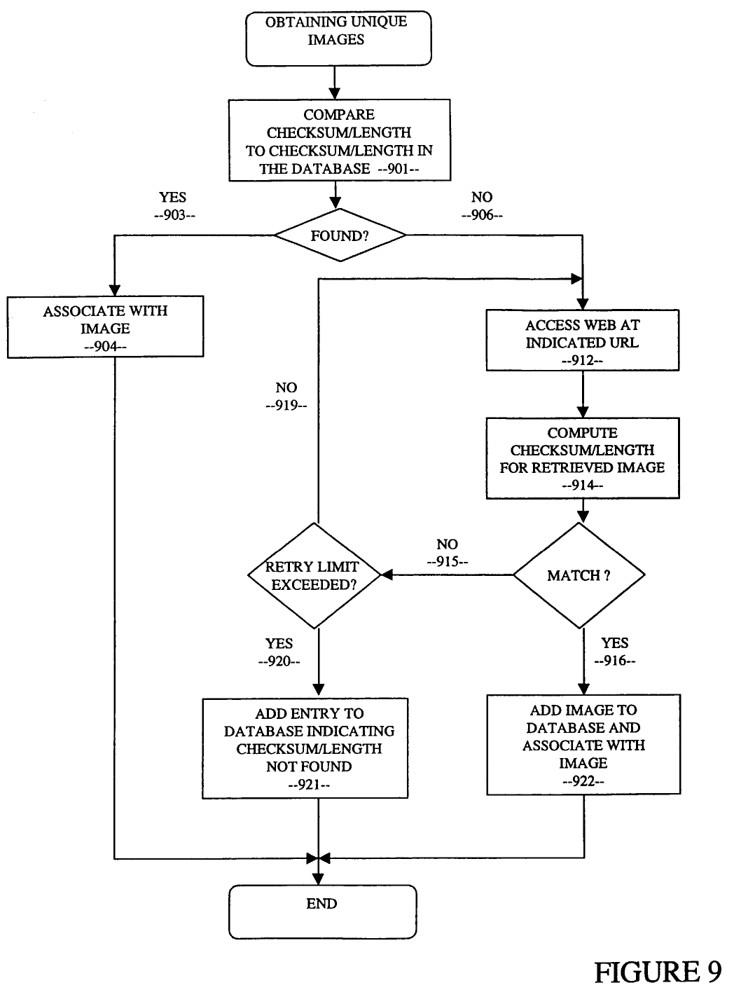

Turning to FIG. 9, an overall flow diagram for finding an actual banner image 102 viewed by a panel member is shown. As has been described, for each HTML page viewed by a panel member, information collected and prepared in a data capture record is sent from the panel member's computer 201 to a proxy server 306 and eventually, to database server 233 for analysis by analysis engine 234. The information contained in a data capture record, detailed in Tables III and IV, includes for each banner image 102, the banner image 102 anchor URL, the banner image 102 URL, the banner image 102 checksum and the banner image 102 length (as shown in Table IV).

The first time a banner image 102 is accessed by a panel member's computer 201, the banner image 102 is stored in the database 223. Stored banner images 102 are also referred to as “banner image masters”. A banner image master comprises the image together with the checksum/length calculated for the image. Each time a banner image 102 is encountered while a user is browsing the Internet, the checksum and length of the a banner image 102 are compared with the checksum/length combinations for previously accessed banner images 102 stored in the database (Block 901). If a match is found (branch 903), the stored banner image 102 is assumed to be the image viewed (Block 904). The data related to the new banner image 102 is not stored in the database, rather the image data is discarded.

If the checksum/length of the new banner image 102 is not found in the database (branch 906), the distributed network (Internet) 210 is then accessed at the indicated URL of the new banner image 102 (Block 912) and the checksum/length is again computed for the retrieved banner image 102 (Block 913). The checksum/length value is computed again because the banner image 102 may, for example, be retrieved from an advertising server. Thus, many ads may match the particular URL, but the checksum/length value for the retrieved banner image 102 may or may not match the checksum/length value for the banner image 102 viewed. If there is not a match (branch 915), the distributed network 210 is accessed again to obtain a different banner image 102, and the process of computing the checksum/length value and comparing it to those values in the database is repeated until a pre-selected retry limit is exceeded (branch 919).

In some cases, the particular image 102 may not be available from the advertisement server and, as a result, no matter how many times the process is repeated the image will not be found. Thus, a retry limit is imposed. If the retry limit is exceed (branch 920), an entry is made in the database indicating that a banner image 102 having a checksum/length value matching the reported checksum length was not found in the distributed network 210 (Block 921).

If a match was found during one of the retry processes (branch 916), the image and its checksum/length value are added to the database (Block 922).

Table V further illustrates the processing performed by the analysis engine 234 for possible HTML return codes and banner image 102 information (see Table III and IV), the cause associated with the return codes, and the processing required by the analysis engine 234 for handling particular page conditions. In Table V, “An” represents the anchor link of banner image 102, “In” represents the image of the banner image 102, “Ln” represents the image length, “Cn” represents the image checksum, “−1” for the length represents an unknown image length and Ax,Ix,Lx,Cx represents any other existing data.

TABLE V
HTML RETURN CODE/BANNER IMAGE 102
INFORMATION PROCESSING

| Case | Why It Happens | Process Needed |
|---|---|---|
| 200 only | Full HTML page | Normal process; |
| | retrieved, page contains no | send information from |
| | banner image 102 | Table III to panel server |
| 200 + An + In + Ln + Cn | Full HTML page | 1. If (An, In) does |
| | retrieved, page contains | not exist, new banner image |
| | banner images(s) 102 | 102 master will be created |
| | | with (Ln, Cn) |
| | | 2. If (An, In) exists |
| | | with (−1, 0), replace this |
| | | banner image 102 with data |
| | | (Ln, Cn) |
| | | 3. If (An, In) exists |
| | | with multiple (Ln, Cn), |
| | | create a new one. |
| 200 + An + In +− 1 + 0 | Full HTML page | 1. If (An, In) does |
| | retrieved. Page contains | not exist, new banner image |
| | banner image 102(s) but the | 102 master should be |
| | banner image 102 is already | created with (−1, 0). |
| | in browser's cache. | 2. If (An, In) exists |
| | | and only has one instance of |
| | | (Ln, Cn), do not create new |
| | | banner image master. |
| | | Existing banner image 102 |
| | | will be used. |
| | | 3. If (An, In) exists |
| | | with multiple (Ln, Cn), |
| | | random pick one. |
| 304 only | HTML page in | 1. Copy all banner |
| | cache. No image(s) is | images 102 from latest 200 |
| | loaded by browser. | page. |
| | | 2. If no 200 page is |
| | | found, ignore banner |
| | | images 102. |
| 304 + An + In + Ln + Cn | 1. HTML page in | 1. Copy banner |
| | cache. | images 102 from latest 200 |
| | 2. New banner | page. |
| | image 102 found. Banner | 2. If (An, In, Ln, Cn) |
| | image 102(s) can be created | exists, ignore the new |
| | from sub-frame page or | banner image 102. |
| | Java script. | 3. If (An, In)s exist |
| | 3. Image 102 is | but have different (Lx, Cx), |
| | retrieved also, | replace all copied |
| | | (An, In, Lx, Cx) with new |
| | | (An, In, Ln, Cn). |
| | | 4. If (An)s exist but |
| | | have different (Ix, Lx, Cx), |
| | | replace all copied |
| | | (An, Ix, Lx, Cx) with |
| | | (An, In, Ln, Cn). |
| | | 5. If no match, |
| | | create one. |
| | | Note: All |
| | | (An, In, Ln, Cn) etc. in 304 |
| | | case only talk about the |
| | | banner image 102 instances |
| | | copied from 200 page. |
| 304 + An + In +− 1 + 0 | 1. HTML in cache. | 1. Copy banner |
| | 2. New banner | images 102 from latest 200 |
| | image 102 found. | page. |
| | 3. Banner image | 2. If (An, In) exists, |
| | 102 is in browser's cache, | use copy version |
| | so no banner image 102 is | 3. If (An) exists, |
| | reloaded, | replace (An, Ix, Lx, Cx) with |
| | | (An, In, −1, 0) |
| | | 4. If no match and |
| | | there is only one banner |
| | | image 102 in 200 page, |
| | | drop old one use new one |
| | | (An, In −1, 0) |
| | | 5. If no match and |
| | | there are multiple banner |
| | | images 102 in 200 page, |
| | | create a new banner image |
| | | 102. |
| 304 + null + In + Ln + Cn | 1. HTML page in | 1. Copy banner |
| | cache | images 102 from latest 200 |
| | 2. New image(s) is | page |
| | retrieved | 2. If (Ax, In, Lx, Cx) |
| | | exists, replace it with |
| | | (Ax, In, Ln, Cn) |
| | | 3. If no match, |
| | | ignore |
| 304 + null + In +− 1 + 0 | 1. HTML page in | ignore |
| | cache | |
| | 2. Image reloaded | |
| | but either the image is | |
| | redirected to a cached | |
| | image or returned with 304 | |

VI. Subscriber Reporting

Once the foregoing data has been collected, the system of the present invention generates comprehensive subscriber reports. The reports include data detailing top Internet sites accessed during a particular period, Internet site reports detailing specific information on activity at particular sites, and ad summary reports summarizing information relating to particular advertisements or banner images 102. The reports may cover any given time period, for example, weekly, monthly or quarterly time period.

In particular, in the described embodiment, five reports are provided showing information relating to top Internet sites including: (i) Top Internet Sites by Unique Site, (ii) Top Internet Sites by Property, (iii) Top Referring Sites by Unique Site, (iv) Top Internet Sites by Domain and (v) Top Navigation Guides by Unique Site. The reports provide information regarding site audience, Internet activity and profile information which include rank, unique audience size, reach, page views, pages viewed from browser cache and pages viewed per person. The SITE_ID and USER_ID are used to uniquely identify a user profile in order to provide demographic information for reporting.

In addition to these reports, on-line access to the database is provided by, for example, the HTTP server 235 (see FIG. 2) which allows template-driven queries, thereby providing customized reports. Other reports available include (i) a Demographic Targeting—Site report providing statistically significant sites based on selected audience characteristics; (ii) a Demographic Targeting—Banner Image report which provides data related to the statistically significant banner images 102 viewed by the target audience; (iii) an Audience Profile—Site report which profiles and compares up to three selected sites demographics, unique audience, composition and coverage site; (iv) an Audience Profiles—Banner Image report which provides audience profiles for selected banner images 102 and includes unique audience, composition, impressions, click rate, reach and frequency with all demographic groupings.

What has been described herein is a method and apparatus for accurately and efficiently counting the number of times an image 102 is viewed by a user of an on-line database or data network, such as the Internet. Although the present invention has been described in detail with particular reference to preferred embodiments thereof, it should be understood that the invention is capable of other and different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A method of providing information on advertisements viewed comprising:
a) instrumenting a viewing device with an instrumentation program;
b) receiving information at the viewing device, the information including advertisements; and
c) collecting information identifying the advertisements received.

2. The method as recited by claim 1 wherein a sample of a population of viewing devices are instrumented with the instrumentation program.

3. The method as recited by claim 1 wherein the advertisements are banner images.

4. The method as recited by claim 1 wherein the collected information comprises a banner image 102 URL, a checksum and a length.

5. A method of determining the reach and frequency of view of an advertisement comprising:
a) instrumenting a viewing device with an instrumentation program;
b) receiving information at the viewing device, the information including advertisements; and
c) collecting information identifying the advertisements received.

6. The method as recited by claim 5 wherein a sample of a population of viewing devices are instrumented with the instrumentation program.

7. The method as recited by claim 5 wherein the advertisements are banner images.

8. The method as recited by claim 5 wherein the collected information comprises a banner image 102 URL, a checksum and a length.

9. A panel computer comprising a first stored program for browsing a distributed network and a second stored program for instrumenting the computer to report information regarding the advertising images viewed on the computer, the computer comprising:
a) a first port coupled in communication with the distributed network;
b) a first storage area storing the first stored program, the first stored program when executed causing the computer to allow user controlled access to the distributed network; and
c) a second storage area storing the second stored program, the second stored program when executed causing the computer to collect statistics on advertisements retrieved from the distributed network and viewed on the computer, the second stored program collecting information regarding the advertisements viewed.

10. The panel computer as cited by claim 9 wherein the advertisements are banner images.

11. The panel computer as recited by claim 9 wherein the collected information comprises a banner image 102 URL, a checksum and a length.

12. The panel computer as recited by claim 9 wherein the distributed network is the Internet.

13. A method of collecting information regarding advertisements viewed by a client computer communicating with a distributed network, the method comprising the steps of:
a) receiving an advertising image from the distributed network at the client computer;
b) deriving a unique identifier identifying the advertising message;
c) reporting the unique identifier to an analysis engine.

14. The method as recited by claim 13 wherein the unique identifier comprises a checksum.

15. The method as recited by claim 13 wherein the unique identifier comprises a checksum and the length of the advertising image.

16. The method as recited by claim 13 wherein the step of reporting to the analysis engine is accomplished by transmitting a message over the distributed network from the client to a server, the message including the unique identifier.
